(19) United States
(12) Patent Application Publication
(10) Pub. No.: US 2025/0061745 A1
(43) Pub. Date: Feb. 20, 2025

(54) MACRO GESTURE RECOGNITION ACCURACY ENHANCEMENTS

(71) Applicant: Samsung Electronics Co., Ltd., Suwon-si (KR)

(72) Inventors: Aditya Dave, Plano, TX (US); Indranil Sinharoy, Richardson, TX (US); Lianjun Li, McKinney, TX (US); Hao Chen, Allen, TX (US); Vutha Va, Plano, TX (US)

(21) Appl. No.: 18/747,259

(22) Filed: Jun. 18, 2024

Related U.S. Application Data
(60) Provisional application No. 63/532,848, filed on Aug. 15, 2023.

(51) Int. Cl. G06V 40/20; G01S 13/50

(52) U.S. Cl. CPC G06V 40/20; G01S 13/50

(57) ABSTRACT

An electronic device includes a transceiver. The transceiver is configured to transmit and receive a plurality of radar signals corresponding with a gesture. The electronic device further includes a processor operatively coupled to the transceiver. The processor is configured to obtain a range Doppler map associated with the plurality of radar signals, and determine a plurality of detection thresholds, each detection threshold corresponding with a range-bin value of the range Doppler map. The processor is further configured to generate, based on the determined plurality of detection thresholds, a time velocity diagram (TVD) and a time angle diagram (TAD) corresponding with the gesture.

### CROSS-REFERENCE TO RELATED APPLICATION(S) AND CLAIM OF PRIORITY

This application claims priority under 35 U.S.C. § 119(e) to U.S. Provisional Patent Application No. 63/532,848 filed on Aug. 15, 2023. The above-identified provisional patent application is hereby incorporated by reference in its entirety.

### TECHNICAL FIELD

This disclosure relates generally to electronic devices. More specifically, this disclosure relates to macro gesture recognition accuracy enhancement.

### BACKGROUND

Gestural interaction with a digital device can be based on different sensor types, e.g., ultrasonic, IMU, optic, and radar. Optical sensors give the most favorable gesture recognition performance. The limitations of optic sensor based solutions, however, are sensitivity to ambient lighting conditions, privacy concerns, and battery consumption. Hence, optic sensor based solutions have the inability to run for long periods of time. LIDAR based solutions can overcome some of these challenges such as lighting conditions and privacy, but the cost is still prohibitive (currently, only available in high-end devices).

### SUMMARY

This disclosure provides apparatuses and methods for macro gesture recognition accuracy enhancements.

In one embodiment, an electronic device is provided. The electronic device includes a transceiver. The transceiver is configured to transmit and receive a plurality of radar signals corresponding with a gesture. The electronic device further includes a processor operatively coupled to the transceiver. The processor is configured to obtain a range Doppler map associated with the plurality of radar signals, and determine a plurality of detection thresholds, each detection threshold corresponding with a range-bin value of the range Doppler map. The processor is further configured to generate, based on the determined plurality of detection thresholds, a time velocity diagram (TVD) and a time angle diagram (TAD) corresponding with the gesture.

In another embodiment, a method of operating an electronic device is provided. The method includes transmitting and receiving a plurality of radar signals corresponding with a gesture, obtaining a range Doppler map associated with the plurality of radar signals, and determining a plurality of detection thresholds, each detection threshold corresponding with a range-bin value of the range Doppler map. The method further includes generating, based on the determined plurality of detection thresholds, a TVD and a TAD corresponding with the gesture.

Yet another embodiment, a non-transitory computer readable medium embodying a computer program is provided. The computer program includes program code that, when executed by a processor of a device, causes the device to transmit and receiving a plurality of radar signals corresponding with a gesture, obtain a range Doppler map associated with the plurality of radar signals, and determine a plurality of detection thresholds, each detection threshold corresponding with a range-bin value of the range Doppler map. The computer program further includes program code that, when executed by a processor of a device, causes the device to generate, based on the determined plurality of detection thresholds, a TVD and a TAD corresponding with the gesture.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIG. 2 illustrates an example electronic device according to embodiments of the present disclosure;

FIG. 3 illustrates an example monostatic radar according to embodiments of the present disclosure;

FIG. 4 illustrates an example gesture recognition system according to embodiments of the present disclosure;

FIG. 5 illustrates another example of gesture recognition systems according to embodiments of the present disclosure;

FIGS. 6A-6C illustrate a method for operating a gesture recognition system according to embodiments of the present disclosure;

FIG. 7 illustrates an example of radar peaks according to embodiments of the present disclosure;

FIG. 8 illustrates an example of TVD and TAD plots according to embodiments of the present disclosure;

FIG. 9 illustrates a method for training an Al based activity detection module according to embodiments of the present disclosure;

FIG. 10 illustrates an example of a TVD 1002 and TAD 1004 with blank background noise data according to embodiments of the present disclosure;

FIG. 11 illustrates a method for rejecting false alarms based on total energy and gesture length thresholds according to embodiments of the present disclosure;

FIGS. 12A-12B illustrate an example of false alarm rejection according to embodiments of the present disclosure;

FIG. 13 illustrates an example convolution neural network architecture for a classifier according to embodiments of the present disclosure;

FIG. 14A illustrates an example of nearly constant detection threshold in a range profile according to embodiments of the present disclosure;

FIG. 14B illustrates an example of variable detection threshold in a range profile according to embodiments of the present disclosure;

FIG. 15 illustrates an example energy profile calculation from raw radar data according to embodiments of the present disclosure;

FIG. 16 illustrates an example of energy based ADM prediction according to embodiments of the present disclosure;

FIG. 17 illustrates an example of normalized data with a threshold vs non-normalized data for a real and synthetically generated gesture according to embodiments of the present disclosure;

FIGS. 18A-18B illustrate an example of false alarm rejection according to embodiments of the present disclosure;

FIGS. 19A-19B illustrate another example of false alarm rejection according to embodiments of the present disclosure;

FIG. 20 illustrates an example of conversion of 2D TVD and TAD data to 1D TVD and TAD data according to embodiments of the present disclosure;

FIG. 21 illustrates an example showing the distinction between the Euclidean and DTW matching according to embodiments of the present disclosure;

FIG. 22 illustrates a method for SLN-DTW matching based activity detection according to embodiments of the present disclosure;

FIG. 23 illustrates an example of template generation between a first and second time series according to embodiments of the present disclosure;

FIG. 24 illustrates a method for SSIM based gesture classification according to embodiments of the present disclosure; and

FIG. 25 illustrates a method for macro gesture recognition accuracy improvement according to embodiments of the present disclosure.

### DETAILED DESCRIPTION

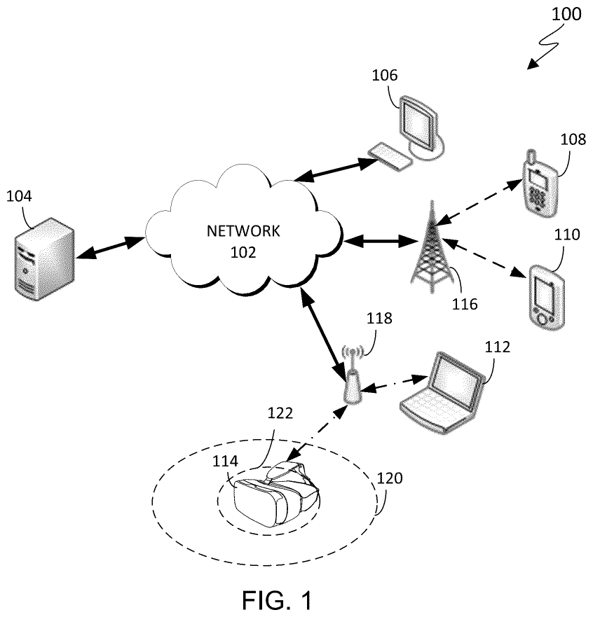

FIGS. 1 through 25, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged gesture recognition system.

FIG. 1 illustrates an example communication system according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head mounted display, AR/VR glasses, a television, an audio playback system or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and AR/VR glasses 114. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can emit and collect radar signals via a radar transceiver. In certain embodiments, the client devices 106-114 are able to sense the presence of an object located close to the client device and determine whether the location of the detected object is within a first area 120 or a second area 122 closer to the client device than a remainder of the first area 120 that is external to the second area 122. In certain embodiments, the boundary of the second area 122 is at a predefined proximity (e.g., 5 centimeters away) that is closer to the client device than the boundary of the first area 120, and the first area 120 can be a within a different predefined range (e.g., 30 meters away) from the client device where the user is likely to perform a gesture.

In this example, some client devices 108 and 110-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

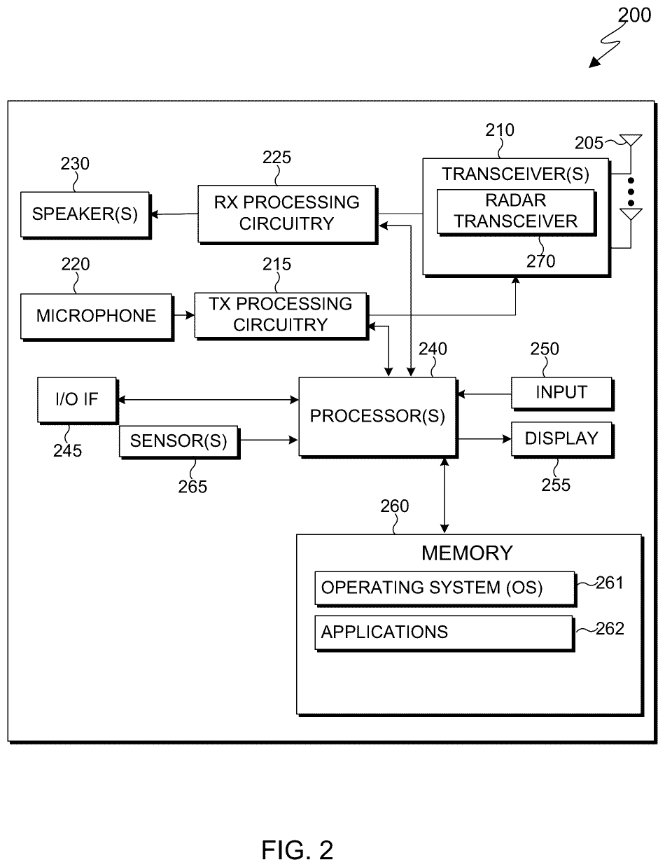

FIG. 2 illustrates an example electronic device according to embodiments of the present disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, or the AR/VR glasses 114 of FIG. 1), a non-portable electronic device such as a television or an audio playback system, a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user in interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11 ay transceiver. The radar transceiver 270 can operate both radar and communication signals concurrently. The radar transceiver 270 includes one or more antenna arrays, or antenna pairs, that each includes a transmitter (or transmitter antenna) and a receiver (or receiver antenna). The radar transceiver 270 can transmit signals at a various frequencies. For example, the radar transceiver 270 can transmit signals at frequencies including, but not limited to, 6 GHz, 7 GHz, 8 GHz, 28 GHz, 39 GHz, 60 GHz, and 77 GHz. In some embodiments, the signals transmitted by the radar transceiver 270 can include, but are not limited to, millimeter wave (mmWave) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

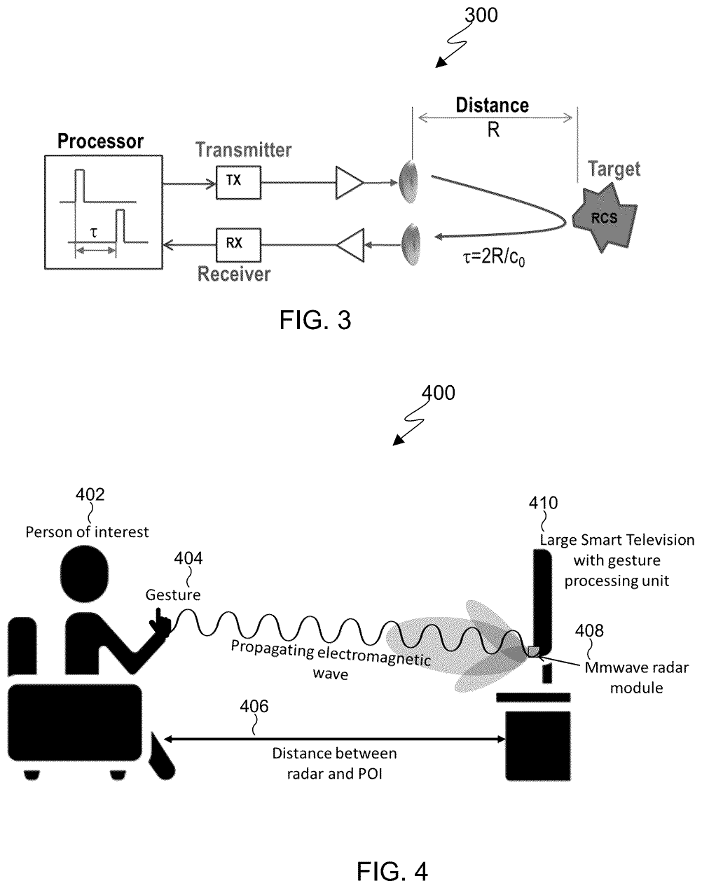

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 3, below, illustrates an example monostatic radar.

In certain embodiments, the radar transceiver 270 can include a transmitter and a receiver. In the radar transceiver 270, the transmitter of can transmit millimeter wave (mmWave) signals. In the radar transceiver 270, the receiver can receive the mmWave signals originally transmitted from the transmitter after the mmWave signals have bounced or reflected off of target objects in the surrounding environment of the electronic device 200. The processor 240 can analyze the time difference between when the mmWave signals are transmitted and received to measure the distance of the target objects from the electronic device 200. Based on the time differences, the processor 240 can generate an image of the object by mapping the various distances.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

A common type of radar is the “monostatic” radar, characterized by the fact that the transmitter of the radar signal and the receiver for its delayed echo are, for all practical purposes, in the same location.

FIG. 3 illustrates an example monostatic radar 300 according to embodiments of the present disclosure. The embodiment of a monostatic radar 300 of FIG. 3 is for illustration only. Different embodiments of a monostatic radar 300 could be used without departing from the scope of this disclosure.

In the example of FIG. 3, a high level architecture is shown for a common monostatic radar, i.e., the transmitter and receiver are co-located, either by using a common antenna, or are nearly co-located, while using separate, but adjacent antennas. Monostatic radars are assumed coherent, i.e., transmitter and receiver are synchronized via a common time reference.

In a monostatic radar's most basic form, a radar pulse is generated as a realization of a desired “radar waveform”, modulated onto a radio carrier frequency and transmitted through a power amplifier and antenna (shown as a parabolic antenna), either omni-directionally or focused into a particular direction. Assuming a “target” at a distance R from the radar location and within the field-of-view of the transmitted signal, the target will be illuminated by RF power density pₜ (in units of W/m²) for the duration of the transmission. The first order, pₜ can be described as:

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} ,$$

where:
P_{T} . . . transmit power [W],
G_{T}, A_{T} . . . transmit antenna gain [dBi], effective aperture area [m²]
λ . . . wavelength of the radar signal RF carrier signal [m],
R . . . target distance [m].
   In this example, effects of atmospheric attenuation, multi-path propagation, antenna losses, etc. have been neglected.

The transmit power density impinging onto the target surface will lead to reflections depending on the material composition, surface shape, and dielectric behavior at the frequency of the radar signal. Note that off-direction scattered signals are typically too weak to be received back at the radar receiver, so only direct reflections will contribute to a detectable receive signal. In essence, the illuminated area(s) of the target with normal vectors pointing back at the receiver will act as transmit antenna apertures with directivities (gains) in accordance with their effective aperture area(s). The reflected-back power is:

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} R C S ,$$

where:
P_{ref1} . . . effective (isotropic) target-reflected power [W],
Aₜ, rₜ, Gₜ . . . effective target area normal to the radar direction [m²], reflectivity of the material & shape [0, . . . , 1], and corresponding aperture gain [dBi],
RCS . . . Radar Cross Section [m²].

Note that the radar cross section, RCS, is an equivalent area that scales proportionally to the actual reflecting area-squared, inversely proportionally with the wavelength-squared and is reduced by various shape factors and the reflectivity of the material. For a flat, fully reflecting mirror of area Aₜ, large compared with λ², RCS=4πAₜ²/λ². Due to the material and shape dependency, it is generally not possible to deduce the actual physical area of a target from the reflected power, even if the target distance is known.

The target-reflected power at the receiver location results from the reflected-power density at the reverse distance R, collected over the receiver antenna aperture area:

$${P}_{R} = \frac{{P}_{refl}}{4 π {R}^{2}} {A}_{R} = {P}_{T} \cdot RCS \frac{{A}_{T} {A}_{R}}{4 {πλ}^{2} {R}^{4}} ,$$

where:
P_{R} . . . received, target-reflected power [W], A_{R} . . . receiver antenna effective aperture area [m²], may be same as A_{T}.

The radar system is usable as long as the receiver signal exhibits sufficient signal-to-noise ratio (SNR), the particular value of which depends on the waveform and detection method used. Generally, in a simpler form:

$$S N R = \frac{{P}_{R}}{kT \cdot B \cdot F} ,$$

where:
kT . . . Boltzmann's constant x temperature [W/Hz],
B . . . radar signal bandwidth [Hz],
F . . . receiver noise factor (degradation of receive signal SNR due to noise contributions of the receiver circuit itself).

In case the radar signal is a short pulse of duration (width) T_{P}, the delay τ between the transmission and reception of the corresponding echo will be equal to τ=2R/c, where c is the speed of (light) propagation in the medium (air). In case there are several targets at slightly different distances, the individual echoes can be distinguished as such only if the delays differ by at least one pulse width, and hence the range resolution of the radar will be ΔR=cΔτ/2=cTₚ/2. Further considering that a rectangular pulse of duration T_{P} exhibits a power spectral density P(f)˜(sin(πfTₚ)/(πfT_{P}))² with the first null at its bandwidth B=1/T_{P}, the range resolution of a radar is fundamentally connected with the bandwidth of the radar waveform via:

ΔR=c/2B.

Although FIG. 3 illustrates an example of a monostatic radar 300, various changes may be made to FIG. 3. For example, various changes to transmitter, the receiver, the processor, etc. could be made according to particular needs.

As wireless technologies continue to advance, connectivity, bandwidth etc. increases to support different types of applications. One of the driving motivations behind this is to improve user experience. The present disclosure provides accuracy improvement steps for a gesture recognition system to improve user experience. Gesture recognition offers more natural ways of human-technology interaction by providing more degrees of freedom than traditional commercial solutions. One example is a TV remote. Even though the remote can have many buttons, pressing buttons is not as quick and natural as using hand gestures. Gesture recognition systems are usually constructed using principles of imaging or radar techniques. A gesture recognition system (e.g., imaging or radar) can be configured to address two types of gestures—micro gestures and macro gestures. Micro-gestures are small hand or finger movements only performed few centimeters from the sensing device. Macro-gestures refer to larger hand or body movements that can be performed up to a few meters away from the sensing device. Imaging techniques like visible light and infrared (IR), have privacy issues. Visible imaging also suffers from environmental effects like lighting conditions. Radar based solutions do not suffer from aforementioned issues, but have much less accuracy than imaging solutions. Currently, radar-based macro gesture recognition systems are not employed in large scale commercial applications. One of the reasons is the lack of robustness and high environmental dependency. The lack of robustness arises from sub-optimal gesture classification accuracies compared to imaging techniques and high false-alarm rate. When user body movement is wrongly detected as a gesture, it is referred to as a false-alarm. Also, many solutions only cater to single users in front of the gesture recognition system. This makes the system environment dependent since it fails if there are other moving obstacles around the primary user. The present disclosure provides methods to reduce the false alarm rates due to user body movements, or presence of multiple users in the sensing vicinity. Some embodiments also focus on improving classification accuracy to make the solution robust enough and have high accuracy while working in a real-time environment.

Gesture recognition can comprise (i.e., but is not limited to) two parts-activity detection and gesture classification. While the role of activity detection is to segment the continually incoming signal stream into portions that may contain gestures of interest and feed these segmented signals to the classification module, the classification module assigns a class to the gesture from amongst a set of pre-defined gestures in an alphabet. In typical gesture recognition systems, only classification accuracy of the performed gestures is analyzed. Also, it is assumed that at all times, valid gestures are presented to the classifier. However, the task of gesture activity detection is not focused upon. Deviations from the expected type of action before and after the gesture performance and the presence of multiple people near the user can cause invalid activity detection that is later fed to the classifier. This increases the amount of false positive and false negative classifications and also deteriorates the training dataset for the classifier. The present disclosure provides methods to address these issues and improve results for activity detection accuracy, gesture classification accuracy, and overall system accuracy that comprises both activity detection and gesture classification.

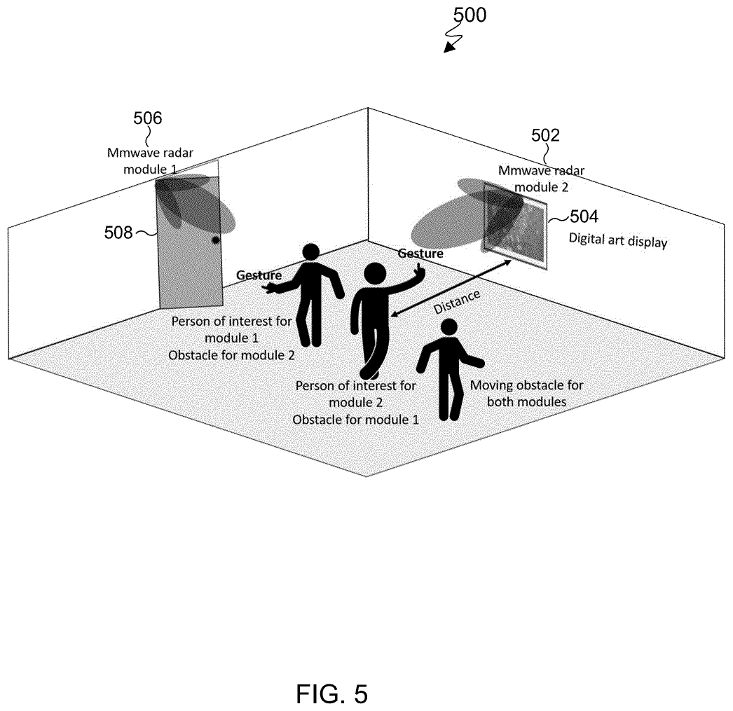

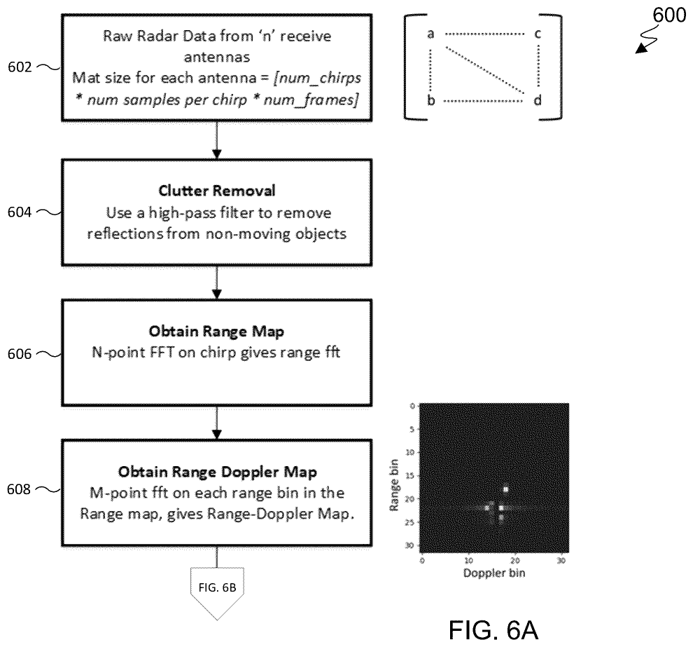

In one embodiment, a gesture recognition system is used to decode an alphabet of hand gestures enabling intuitive interactions with different devices and applications. The system uses millimeter wave technology and a radar hardware for transmitting electromagnetic signals. These signals travel wirelessly and interact with users in the environment. Depending on the gestures performed by the user, the reflected electromagnetic signals encode distinct signatures of object velocity and angle of movement with respect to time. These Doppler signatures are separated into distinct gesture segments by an activity detection module (ADM). Further, these gesture segments are distinguished by a gesture classifier module. All the signal processing related to generating, transmitting and receiving the EM signals, along with the processing related to the activity detection and the classifier modules can either be performed in real time in an independent and integrated gesture processing unit or inside the assembly used for the application. An energy threshold-based approach is implemented in the activity detection module to reduce the false alarm rate of gesture detection and to eliminate the signal received due to the presence of other moving objects in the vicinity. This filtering is done by limiting the domain of operation to the radar module and primary user directly in front of the module. This allows presence of different radar modules simultaneously in the same space to allow for multiple applications. Additional methods are provided to improve the classifier accuracy by specifying both start and end of the gestures manually, or calculating them through the ADM to remove pre-gesture contribution to mis-classification. Components of an example gesture recognition system are shown in FIG. 4 and FIG. 5.

FIG. 4 illustrates an example gesture recognition system 400 according to embodiments of the present disclosure. The embodiment of a gesture recognition system of FIG. 4 is for illustration only. Different embodiments of a gesture recognition system could be used without departing from the scope of this disclosure.

The example of FIG. 4 shows a single user 402 performing gestures 404 at a certain distance from a millimeter wave radar unit 408 located on an electronic device (i.e., a smart TV) 410.

Although FIG. 4 illustrates an example gesture recognition system 400, various changes may be made to FIG. 4. For example, various changes to the distance, the type of electronic device, etc. could be made according to particular needs.

FIG. 5 illustrates another example of gesture recognition systems 500 according to embodiments of the present disclosure. The embodiment of the gesture recognition systems of FIG. 5 is for illustration only. Different embodiments of gesture recognition systems could be used without departing from the scope of this disclosure.

In the example of FIG. 5, there are moving obstacles and different gesture recognition systems in the same room, each one catering to a different user and application. One gesture recognition system 502 is located on a digital art display 504 for enabling use of gestures to navigate more naturally though different art. Another gesture recognition system 506 is located on a door 508 where one user controls the opening and closing of door using gestures.

Although FIG. 5 illustrates an example of gesture recognition systems 500, various changes may be made to FIG. 5. For example, various changes to the distances, the types of electronic device, etc. could be made according to particular needs.

There are other uses cases for gesture recognition systems apart from the ones shown in FIG. 4 and FIG. 5, including but not limited to some home automation examples like, controlling A/C temperature, operating laundry machine, opening doors of refrigerator, dishwasher, operating coffee machine, etc.

In one embodiment, the gesture recognition system comprises a radar module operating at a certain frequency and a gesture processing unit co-located with the radar module. In one embodiment, the radar operates at millimeter wave (mm-wave) frequency of 60 GHz. In some other embodiments, the radar may operate at other higher or lower frequencies and cover different electromagnetic bands including but not limited to S-band (2 GHz to 4 GHz), C-band (4 GHz to 8 GHz), X-band (8 GHz-12 GHz), Ku-band (12 GHz-18 GHz), K band (18 GHz-26 GHz), Ka band (26.5 GHz-40 GHz), V band (40 GHz-75 GHz) and W-band (75 GHz-100 GHz) etc. The radar system may cater to one of more users who are located at different distances from the radar module. The users may perform certain gestures defined in a pre-decided pool of gesture alphabets which is classified by the gesture processing unit.

In one embodiment, the millimeter wave module generates a signal that is radiated in free-space using one or more transmitter antennas shown as for example in FIG. 4. This signal travels wirelessly as a propagating electromagnetic wave and reaches a static or moving target. The target absorbs and diffracts a certain amount of signal depending on its material composition. Part of the reflected signal reaches back to the radar, and it is captured using one or more receiving antennas. When the signal travels the round trip wirelessly, it has certain attenuation in free space depending on the distance travelled and the frequency of operation. If the distance travelled is too large, or the area of the reflecting object is too small, the reflected signal tends to have low power. If the signal-to-noise ratio (SNR) at the receiver is less than the sensitivity limit, signal components cannot be reliably distinguished. The appropriate range of the obstacle to get a good SNR and operating frequency to be used are thus decided depending upon the area and distance of the reflecting object using the radar range equation.

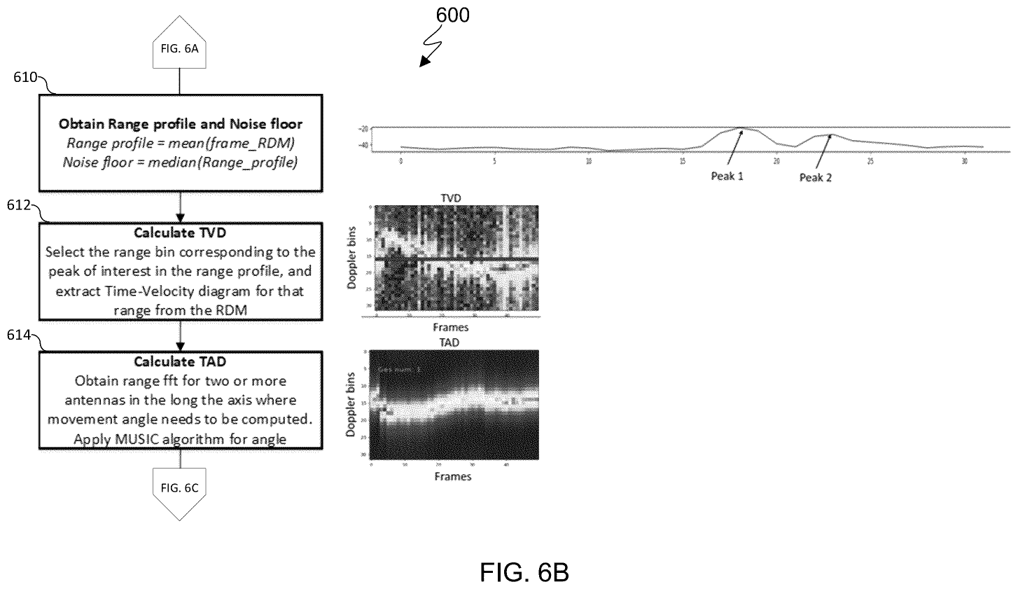

Once the signals are received by the receiver antennas, they go to the gesture processing unit located with the millimeter wave radar module. FIGS. 6A-6C show a flow diagram of an example operation of a signal processing unit to arrive at the classified gesture from the raw radar data.

FIGS. 6A-6C illustrate a method 600 for operating a gesture recognition system according to embodiments of the present disclosure. An embodiment of the method illustrated in FIGS. 6A-6C is for illustration only. One or more of the components illustrated in FIGS. 6A-6C may be implemented in specialized circuitry configured to perform the noted functions or one or more of the components may be implemented by one or more processors executing instructions to perform the noted functions. Other embodiments of a method 600 for operating a gesture recognition system could be used without departing from the scope of this disclosure.

Method 600 begins at step 602. At step 602, raw data is acquired at each receive antenna. The raw data size is a function of the number of chirps and number of samples per chirp. One embodiment uses a frequency modulated continuous wave (FMCW) radar system to generate and transmit chips of signal around the center frequency with a bandwidth (B). The range resolution of the radar is given by (a)

$$r = \frac{c}{2 B} \qquad ( 1 )$$

where c is the speed of light which is equal to 3*10⁸ m/s. The total range of the radar is determined number of samples per chirp and the slope of the chirp (S). The range of the radar is given by (2)

$${d}_{max} = \frac{{F}_{s} . c}{2 S} \qquad ( 2 )$$

where Fs is the sampling rate of the analog to digital converter (ADC) and directly relates to the number of samples per chirp.

For example, if B is 5 GHz, the range-resolution r is equal to 3 cm using equation (1). If the sampling frequency of the ADC is 2.5 MHz for example, and the slope of the chirp is 10¹⁴ s⁻², the maximum distance where an object can still be detected by the radar is 3 m using equation (2). Using higher bandwidth can offer finer range-resolution but also increases the noise power leading to degraded SNR. Hence even though theoretically the maximum range is independent of the radar bandwidth, a degraded SNR using higher bandwidth might mean that only large objects can be efficiently detected since they reflect more power on average. Therefore, there is a trade-off between using appropriate range resolution and maximum range of the radar which depends on the application. Higher bandwidth along with more chirps and more samples per chirp also increases the total amount of data to be acquired which can limit real-time performance based on hardware capabilities.

When an object is within the maximum range of the radar, the reflected signal received by the radar contains information pertaining to the location and velocity of the object. Depending on the number of chirps transmitted and the ADC sampling rate, each receiving antenna outputs a 3D matrix of data with size [num_chirps*num_samples_per_chirp*num_frames].

At step 604, effects of stationary and slowly moving objects in the vicinity of measurement range are eliminated. Since the radar is also assumed to be stationary, the reflected signals from these stationary and slowly moving objects can be filtered out using zero-Doppler nulling and clutter removal. In one embodiment, while the zero-Doppler nulling is achieved by simply setting the values in the zeroth Doppler bin to zero or to the smallest positive representable value in the particular machine's floating point type, the clutter removal filter is implemented using an infinite impulse response (IIR) filter, which uses current and previous inputs and outputs to filter data which does not change in time.

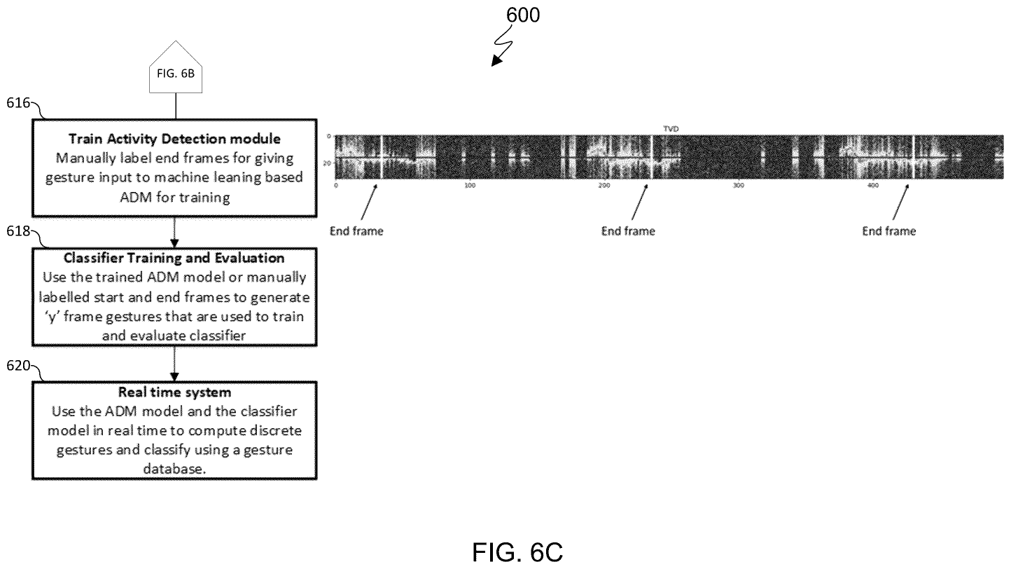

Once the clutter removal is implemented for filtering stationary objects, the range doppler map is created. This is done in two steps, by computing a range FFT at step 606 and Doppler FFT at step 608. When a chirp is transmitted and reflects from an object, the receiver gets a delayed version of the chirp. The time difference between the transmitted and received chirp is directly proportional to the range of the object. The difference in the transmitted chirp frequency (f1) and received chirp frequency (f2) is calculated by passing both the chirps through a mixer establishing an intermediate frequency (IF) which produces a signal with frequency, f1+f2, and another with frequency f1-f2. When both chirps are passed through a low-pass filter such that only the chirp with frequency f1-f2 remains, an FFT can be performed on that temporal signal to reveal the frequency value. The location of the peaks in the frequency spectrum directly correspond to the range of the objects. FIG. 7 shows an example of how the radar signal can be distinguished for reflections from the hand and the body of a user.

FIG. 7 illustrates an example of radar peaks 700 according to embodiments of the present disclosure. The embodiment of radar peaks of FIG. 7 is for illustration only. Different embodiments of radar peaks could be used without departing from the scope of this disclosure.

In the example of FIG. 7, a radar signal 702 is transmitted and received from a gesture recognition system 704. Radar signal 704 is reflected from user 706. A body peak 708 corresponds with radar signal 702 reflecting off of user 706's body, and hand peak 710 corresponds with radar signal 702 reflecting off of user 706's hand.

Although FIG. 7 illustrates an example of radar peaks 700, various changes may be made to FIG. 7. For example, various changes to the distances, the hand location, etc. could be made according to particular needs.

Once the range profile is obtained at step 610, relevant peaks are selected. In FIG. 7 for example, only the first peak corresponding to the hand is relevant, since hand gestures are analyzed in this embodiment. Therefore, only the range bin corresponding to the hand peak is selected. In order to obtain the velocity and angular motion of the hand, doppler FFT is calculated. For the selected range bin, an FFT is calculated for each of the transmitted chirps. All the chirps will have the same peak location (range) but differing phase value. This FFT, called a Doppler FFT helps in finding the velocity of the object and constructing a Time-Velocity Diagram (TVD) at step 612.

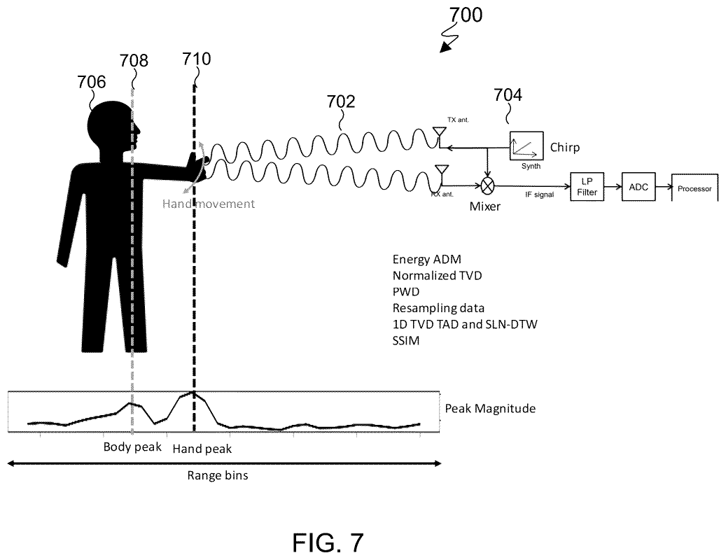

For finding the angle of movement, the range FFTs due to all chirps are considered at multiple receiver antennas. These receiver antennas must be spatially separated along the axis where angular movement needs to be calculated. When this happens, the same chirp is received at the different antennas with same magnitude, but a different phase governed by the separation between the receiving antennas. The difference in phase information can be used at step 614 to compute the angle-vs-time (TAD) plot of the object using a MUSIC algorithm. Other algorithms can also be used to extract the angle. FIG. 8 shows example TVD and TAD plots for three different hand gestures that are implemented in one embodiment of the present disclosure.

FIG. 8 illustrates an example 800 of TVD and TAD plots according to embodiments of the present disclosure. The embodiment of TVD and TAD plots FIG. 8 is for illustration only. Different embodiments of TVD and TAD plots could be used without departing from the scope of this disclosure.

In the example of FIG. 8, TVD plots 820 and TAD plots 830 correspond with a swipe right hand gesture 810. Additionally, TVD plots 850 and TAD plots 860 correspond with a swipe left hand gesture 840. Furthermore, TVD plots 880 and TAD plots 890 correspond with a swipe left hand gesture 870.

Although FIG. 8 illustrates an example 800 of TVD and TAD plots, various changes may be made to FIG. 8. For example, various changes to the hand gestures, the data captured, etc. could be made according to particular needs.

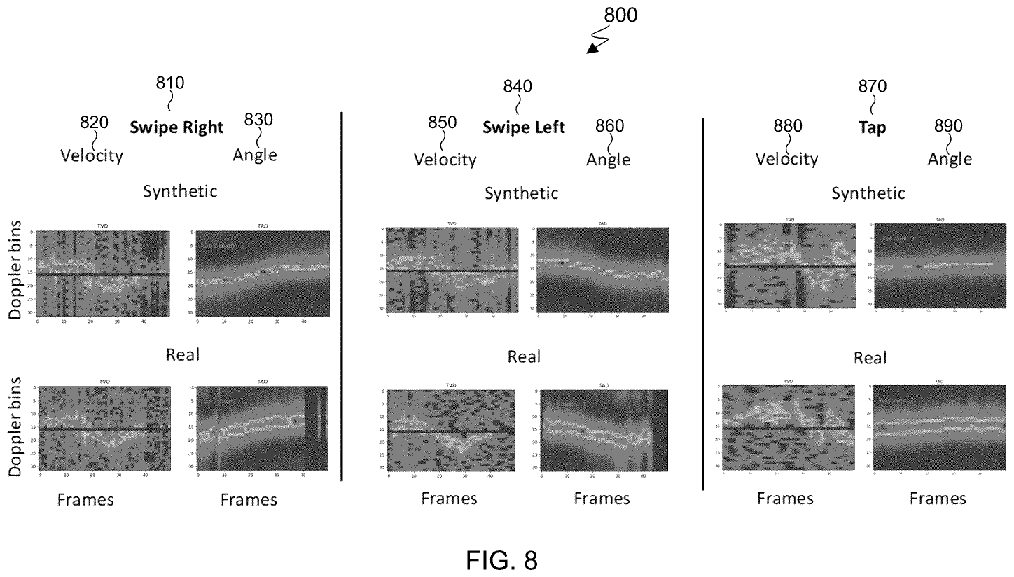

Steps 616 and 618 in FIG. 6C refer to activity detection module (ADM) (step 616) and classifier module (step 618) implementation. Once the velocity and angle are calculated for all frames of data (or each frame in a real time data), the activity detection module (ADM) predicts where gestures actually took place in the continuous stream of data based on the gesture energy and filters out the rest of the data. The accuracy of the ADM determines the quality of gestures that are obtained and the resulting classification accuracy. FIG. 9 shows a flowchart for an example method of generating samples for training an Al based ADM. Finally, at step 620, the trained ADM and classifier models are used in a real time system tom compute discrete gestures and classify the gestures using a gesture database.

Although FIGS. 6A-6C illustrate one example of a method 600 for operating a gesture recognition system, various changes may be made to FIGS. 6A-6C. For example, while shown as a series of steps, various steps in FIGS. 6A-6C could overlap, occur in parallel, occur in a different order, or occur any number of times.

FIG. 9 illustrates a method 900 for training an Al based activity detection module according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method 900 for training an Al based ADM could be used without departing from the scope of this disclosure.

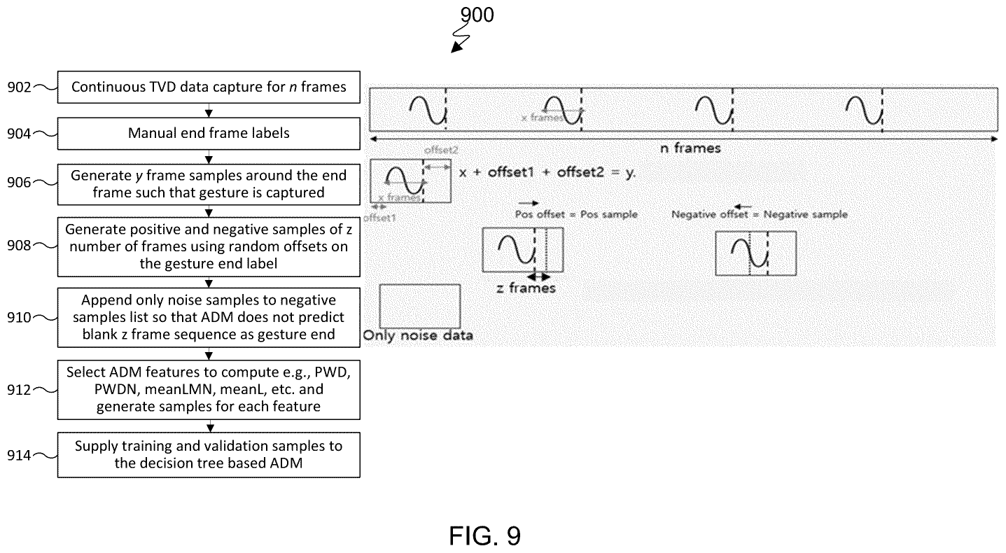

Method 900 begins at step 902. At step 902, In a continuous stream of data, different gestures are recorded. In another embodiment discrete n frame samples each comprising a gesture can be recorded. At step 904, these gestures are manually labeled for determining the end frame based on the energy associated with the gesture. For example, energy detected above a predetermined threshold may be associated with the gesture, and energy detected below the predetermined threshold may be unrelated to the gesture. At steps 906 and 908, for each gesture and corresponding end frame, positive and negative offsets are generated. Positive offsets refer to end of the gesture after the labeled end and negative offsets refer to end of the gesture before the labeled end. The negative offsets samples act as negative samples to help the ADM learn that ending the gesture while activity is occurring is incorrect. At step 910, the negative samples are reinforced with blank background noise data, which also helps the ADM to learn to not recognize end of gesture when n frames of blank background noise data exist between two gestures. FIG. 10 illustrates an example 1000 of a TVD 1002 and TAD 1004 with blank background noise data. At step 912, ADM features are selected to compute, such as PWD, PWDN, meanLMN, meanL, etc. and samples are generated for each feature. At step 914, training and validation samples are supplied to the decision tree based ADM.

Although FIG. 9 illustrates one example of a method 900 for training an Al based ADM, various changes may be made to FIG. 9. For example, while shown as a series of steps, various steps in FIG. 9 could overlap, occur in parallel, occur in a different order, or occur any number of times.

In some gesture recognition systems, there is no activity detection module, and the classification is not performed in real-time. In these systems, the ADM obtains the relevant gestures from continuous data, and the false alarms are filtered out manually before the gestures are fed to the classifier. Alternatively, the classifier can be trained to detect non-gestures, which are outside the pool of the gesture alphabet, and the false-alarms can be filtered using the classifier. However, this introduces additional learning complexity for the machine learning model. The present disclosure provides a non-machine learning based method to reduce the false alarm rates that arise as data collection artifacts. These include random small or large body movements between two gestures, and the effect of presence of other moving obstacles alongside or behind the user. In one embodiment, the false alarm rates are reduced by filtering out gesture segments using a combination of energy threshold and minimum gesture-length threshold in the ADM module. In one embodiment, the ADM is implemented using a binary decision tree-based machine learning model.

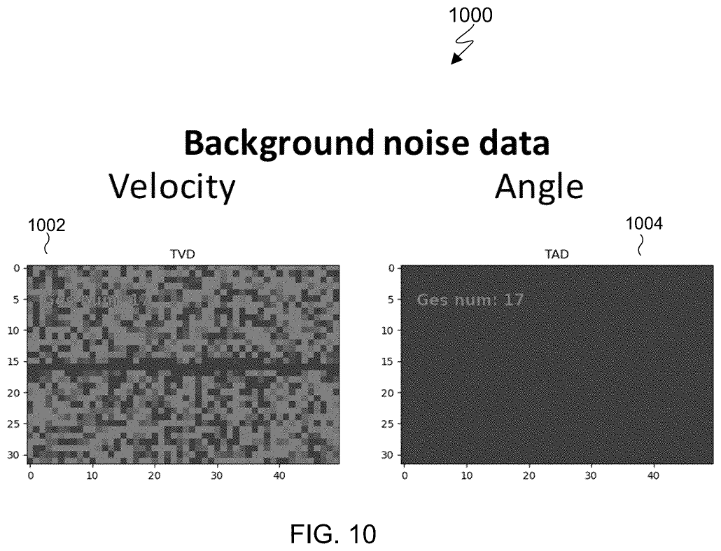

When the trained ADM module is used to extract gestures from a continuous frame of data, the resulting gestures may contain a lot of false alarms. These false alarms are reduced by the energy and gesture-length threshold process provided herein. FIG. 11 shows a flowchart for an example implementation of the threshold-based method.

FIG. 11 illustrates a method 1100 for rejecting false alarms based on total energy and gesture length thresholds according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method 1100 for rejecting false alarms based on total energy and gesture length thresholds could be used without departing from the scope of this disclosure.

In the example of FIG. 11, method 1100 begins at step 1102. At step 1102, y is calculated for x number of chirps per frame in a TVD, where y is the length of the gesture. At step 1104, the gesture energy is calculated as the sum of the intensity of all y for x number of chirps per frame pixels. At step 1106, it is determined if the gesture energy is less than a lower bound (i.e., a lower energy threshold) or greater than an upper bound (i.e., an upper energy threshold), the method proceeds to step 1108, where the gesture is determined to be an invalid gesture (i.e., a false alarm). Otherwise, if the energy is greater than the lower bound and less than the upper bound, the method proceeds to step 1110.

At step 1110, the total energy of pixels in each 1×number of chirps per frame column is calculated. At step 1112, if the energy is less than an upper energy threshold for more than x out of y columns, the method proceeds to step 1114, where the gesture is determined to be an invalid gesture (i.e., a false alarm). Otherwise, if the energy is greater than the threshold for more than x out of y columns, the method proceeds to step 1116 where the gesture is correctly identified.

Although FIG. 11 illustrates one example of a method 1100 for rejecting false alarms based on total energy and gesture length thresholds, various changes may be made to FIG. 11. For example, while shown as a series of steps, various steps in FIG. 11 could overlap, occur in parallel, occur in a different order, or occur any number of times.

In one embodiment, for total energy calculation, all pixels in the TVD velocity plots are summed together similar to step 1104. In one embodiment, the energy for all the TVDs are manually observed to identify energy differences between real gestures and false alarms. The energy differences indicate that it is possible to set a higher and lower threshold. If the energy lies between the thresholds, the gesture is classified as true, similar as shown at step 1106. If the energy is outside the threshold bounds, then the gesture is classified as a false alarm. In another embodiment, for large gesture datasets, a machine learning model can be trained on true labels of gestures and false alarms. This model can be used for evaluating unknown datasets and predicting whether the gesture is a false alarm. For gesture length calculation, all pixels in a column (frame) of TVD are averaged similar to step 1110. If the average value is less than an empirically set threshold value, no gesture is occurring within that frame similar to step 1112. If more than a certain number of frames show that a gesture is occurring, only then is that gesture valid, otherwise, the gesture is considered as a false alarm. The empirical value of threshold in this case is set based on a priori knowledge of how long it takes at a minimum to perform a gesture. This threshold should be changed if the frame rate of the radar or gesture definition changes.

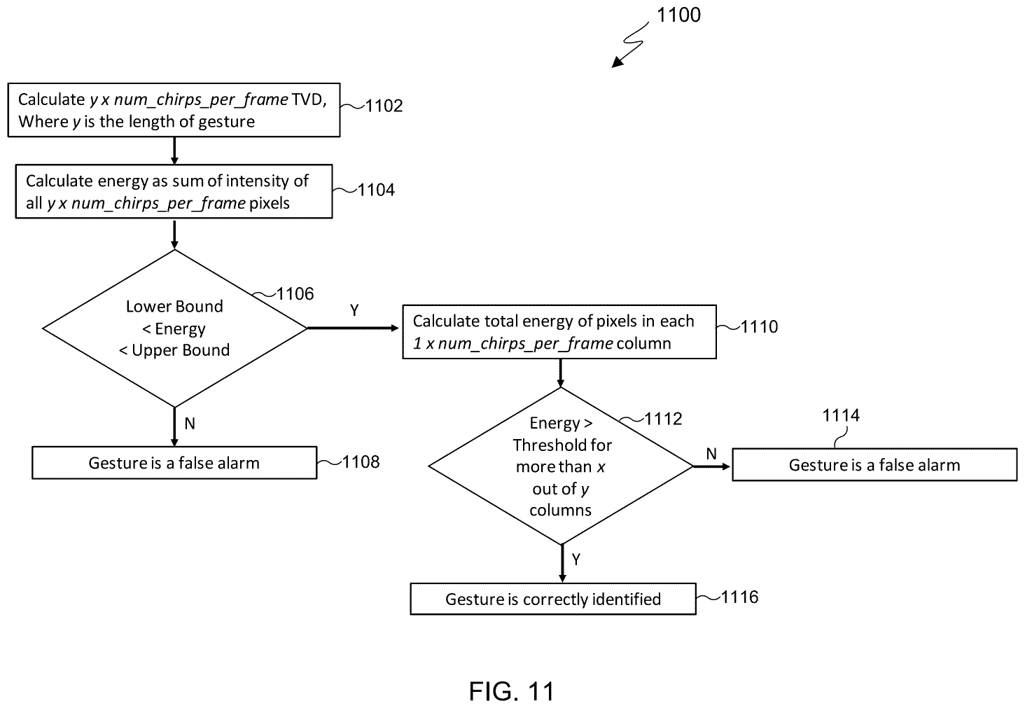

FIGS. 12A-12B illustrate an example 1200 of false alarm rejection according to embodiments of the present disclosure. The embodiment of false alarm rejection of FIGS. 12A-12B is for illustration only. Different embodiments of false alarm rejection could be used without departing from the scope of this disclosure.

FIG. 12A shows the energy based and gesture length-based thresholds working together successfully to find false alarms in a dataset. In the example of FIG. 12A, a series of 10 gestures is shown. Gestures 2, 3, and 9 are successfully identified as false alarms (FA) based on lower energy threshold and gesture length threshold. Gesture 0 is successfully identified as FA based on higher energy threshold. The lower set of 10 gestures shows implementation of the ADM for the same set of data, after the threshold implementation is included. None of the false alarms appear in the resulting gestures. FIG. 12B shows the energy threshold plot for each gesture in FIG. 12A before threshold implementation, with higher and lower energy threshold values indicated.

Although FIGS. 12A-12B illustrate an example 1200 of false alarm rejection, various changes may be made to FIGS. 12A-12B. For example, various changes to the gestures, the threshold, etc. could be made according to particular needs.

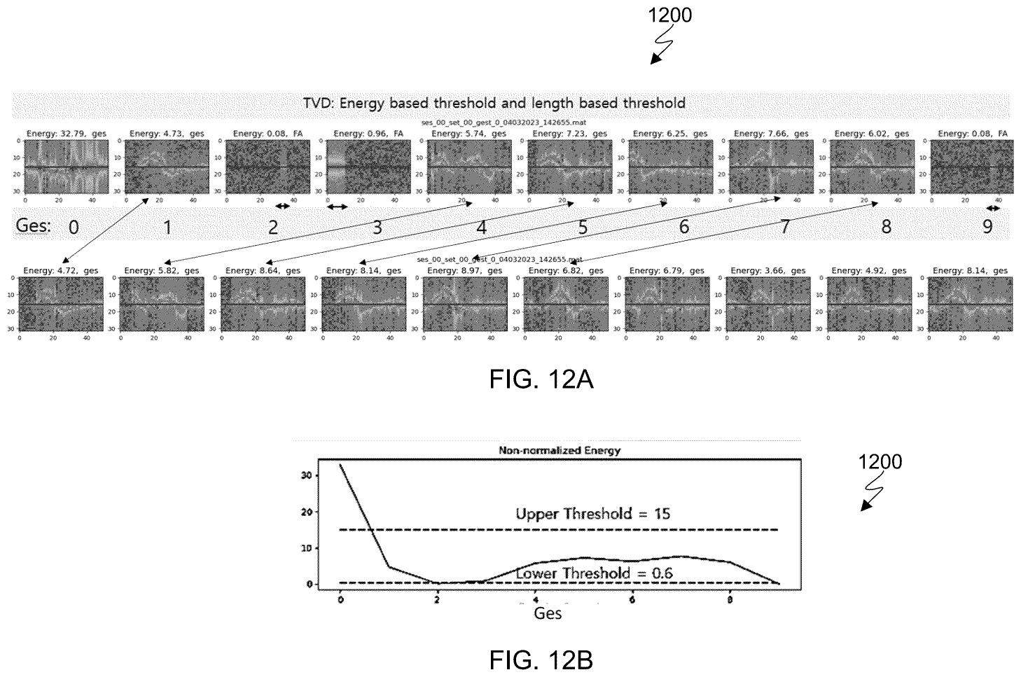

Threshold implementation for reduction in false alarm rates helps to produce better quality of gestures for training the classifier module. In one embodiment, a machine learning classifier operating on a convolutional neural network (CNN) is used. The model may contain certain number of layers including but not limited to those shown in FIG. 13.

FIG. 13 illustrates an example convolution neural network architecture for a classifier 1300 according to embodiments of the present disclosure. The embodiment of the CNN architecture of FIG. 13 is for illustration only. Different embodiments of a CNN architecture could be used without departing from the scope of this disclosure.

In the example of FIG. 13, the CNN architecture includes the following layers:
2D convolution (1302)
Rectified Linear Unit Activation (1304)
Blurpool (1306)
Batch Normalization (1308)
Max Pooling 2D (1310)
Dropout (1312)
2D convolution (1314)
Rectified Linear Unit Activation (1316)
Blurpool (1318)
Max Pooling 2D (1320)
Dropout (1322)
Flatten (1324)

Although FIG. 13 illustrates an CNN architecture for a classifier 1300, various changes may be made to FIG. 13. For example, various changes to the number of layers, the type of layers, etc. could be made according to particular needs.

In one embodiment, using the classifier architecture in FIG. 13, the classifier is first trained on gestures obtained using manually labeled end frames. It is observed that the average gesture accuracy is limited for a leave one out test across users. For a pool of ‘n’ users, the leave one out test uses n−1 users to train the model and tests it on the nth user. This is repeated for all n users and then the average accuracy is reported. Further boosting the accuracy of the classifier in this controlled environment (where gesture ends are manually labeled for consistency, no ADM module), is useful in order to improve the overall system accuracy. System accuracy refers to the accuracy when gestures are processed by the ADM module and the resulting accuracy is found using the classifier.

In one embodiment, the classifier is implemented to use a fixed number of frames of data for training and evaluation. In one method of ADM design, the ADM is used to predict the end frame of the gesture. In this implementation, a trace-back method of a fixed number of frames before the end frame is used to get the full buffer for the classifier. Because not all gestures are exactly a predefined fixed number of frames in length (end frame—start frame), in yet another embodiment, where both start and end of the gestures are detected by the ADM, a resample model is used on the gestures so that a fixed number of frames is achieved. For example, the fixed number of frames may correspond to a predetermined maximum length. The resample model may then resample the TAD data and TVD data to create resampled TAD data and resampled TVD data that match the fixed number of frames. Then the fixed number of frames can be used with the existing classifier design. The benefit of specifying the start of the gesture is that it helps to reject the pre-gesture hand movements, which can sometimes influence the results negatively.

In typical gesture recognition systems, the subject is fixed at a certain range of distances from the radar and the radar system is developed to detect objects at those distances. The present disclosure provides an adaptive detection threshold which changes as a function of the noise floor and the distance from the radar. For an FMCW radar, parameters like bandwidth, chirp duration, number of chirps, number of samples per chirp, ADC sampling rate and IF gain greatly impact the range of the radar. There are different trade-offs between increasing range of the radar and sensing ambient noise. For example, as the detection range increases, for larger distances the power sharply drops. At the same time, a higher IF gain that is used for detecting small objects far from the radar greatly increases the ambient noise level sensing. These differences can be observed in the range profile obtained by taking a range FFT of the range-doppler map.

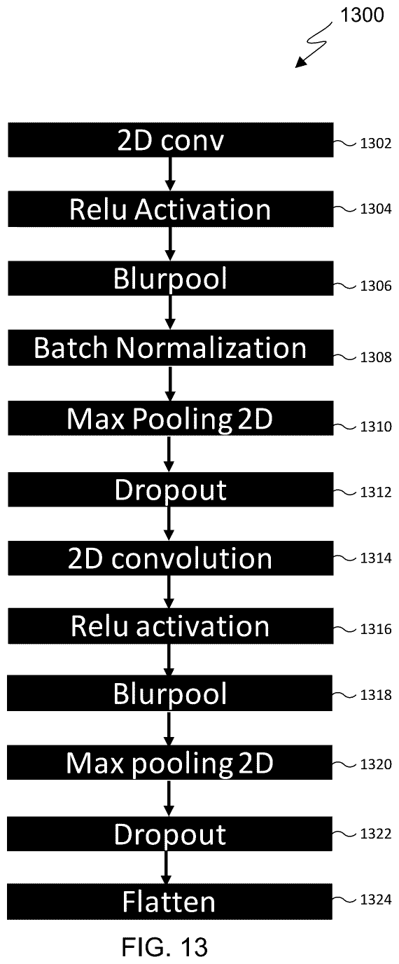

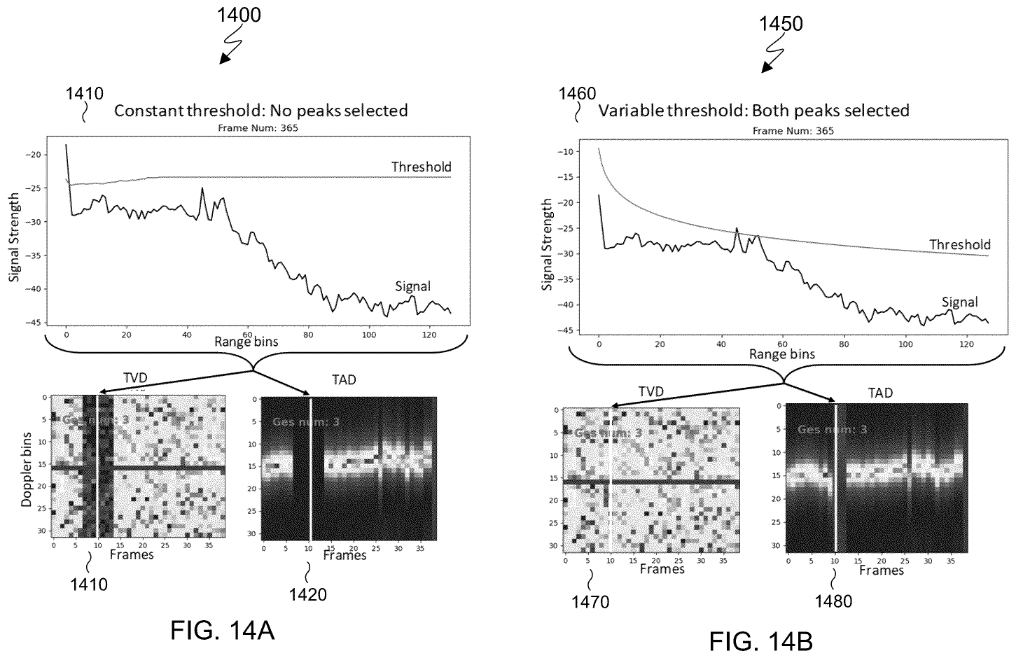

Some techniques use a nearly constant threshold for peak detection in the range profile. The peak detection threshold is essentially a constant offset from the noise-floor. The noise floor is obtained by taking the median of the range profile. This is because most of the range-bins do not have a valid object to sense and the power level in them represents the power of the ambient noise which can be captured by taking the median. The noise-floor is an environmental characteristic which changes with time but not distance. So different frames can have a different noise-floor, but the noise floor level does not change across different range-bins in the same frame. A nearly constant offset is added to the noise-floor to get the detection threshold. Since the offset is constant and the noise floor is also constant, the detection threshold remains nearly constant. If the peak is above the threshold at a particular range-bin, it indicates that there is a relevant object present, whose velocity can be obtained by taking the doppler FFT at that range-bin. However, sometimes if the threshold level is not optimally set, even noise peaks can spike above the threshold leading to incorrect TVD and TAD plots. This becomes especially concerning if the object is far from the radar. A constant detection threshold then causes the noise peaks in closer range bins to the radar to have much higher power than the range bins corresponding to the object, which has a lower strength due to the larger distance. This discrepancy is shown in FIG. 14A.

FIG. 14A illustrates an example 1400 of nearly constant detection threshold in a range profile according to embodiments of the present disclosure. The embodiment of nearly constant detection threshold of FIG. 14A is for illustration only. Different embodiments of a nearly constant detection threshold could be used without departing from the scope of this disclosure.

In the example of FIG. 14A, range profile 1410 related to a gesture input has a nearly constant detection threshold resulting in TVD plot 1420 and TAD plot 1430. The range profile shows 1410 rapidly decaying signal strength for a particular frame. The nearly constant detection threshold does not successfully detect any of the two peaks, one due to the user's hand, and other due to the user's body.

Although FIG. 14A illustrates example 1800 of nearly constant detection threshold in a range profile, various changes may be made to FIG. 14A. For example, various changes to the number of peaks, the threshold level, etc. could be made according to particular needs.

FIG. 14B illustrates an example 1450 of variable detection threshold in a range profile according to embodiments of the present disclosure. The embodiment of variable detection threshold of FIG. 14B is for illustration only. Different embodiments of a variable detection threshold could be used without departing from the scope of this disclosure.

In the example of FIG. 14B, range profile 1460 related to the same gesture input as FIG. 14A has a variable detection threshold, but the same signal plot illustrated in FIG. 14A, resulting in TVD plot 1470 and TAD plot 1480. The variable detection threshold successfully detects the two peaks, one due to the user's hand, and other due to the user's body.

Although FIG. 14B illustrates example 1850 of variable detection threshold in a range profile, various changes may be made to FIG. 14B. For example, various changes to the number of peaks, the threshold level, etc. could be made according to particular needs.

In one embodiment, a detection threshold is implemented which is a function of the distance from the radar. Such a detection threshold can be implemented using equation (3) and can properly sense objects in close range as well as farther distances without making any changes in the peak detection algorithm. For the same gesture shown in FIG. 14A, FIG. 14B shows performance with improved distance-based threshold detection which helps to get correct TVD and TAD curves. The improved detection threshold detects both peaks caused by the user's hand and body properly which leads to improved TVD and TAD curves for large distances.

$$det\_th = {σ}^{2} ( 1 + \frac{K}{\sqrt{N}} ) \frac{M}{p * \frac{c}{2 B}} \qquad ( 3 )$$

where σ² is the noise floor, N is the size of range-fft, K is a parameter that controls false-alarm rate, M is empirically calculated based on the minimum SNR observed while sensing, p is the range-bin number, B is the bandwidth of the system and c is the speed of light.

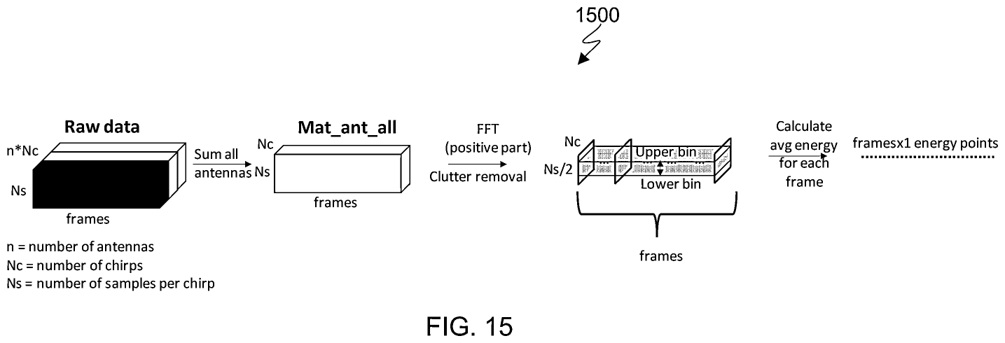

In one embodiment, the activity detection module is implemented using energy calculations, instead of the machine learning approach. FIG. 15 shows an example approach for obtaining an energy profile from raw data at ‘n’ receive antennas.

FIG. 15 illustrates an example energy profile calculation from raw radar data 1500 according to embodiments of the present disclosure. The embodiment of the energy profile calculation of FIG. 15 is for illustration only. Different embodiments of an energy profile calculation could be used without departing from the scope of this disclosure.

In the example of FIG. 15, the raw data at each of the receive antennas is summed. The frame range Doppler map (RDM) is computed similar to steps 606 and 608 in FIG. 6A. By having a priori knowledge of what approximate range the object will be present in, the upper and lower threshold of the range bins are set. The average energy for each frame is computed for all of these range bins. The resulting energy profile is a 1D vector with length of the number of frames of data. The energy profile obtained from raw data is subject to a moving average filter to moving average filter to compute Short-Term Average (STA) power. STA power gating thresholds are empirically set to evaluate whether activity is being performed in a particular range-bin. STA power gating may be referred to as a STA power operation. Once the thresholds successfully produce results similar to manually labeled data for different use-cases, the ADM model can be evaluated on unknown data.

Although FIG. 15 illustrates one example of energy profile calculation from raw radar data 1500, various changes may be made to FIG. 15. For example, while shown as a series of steps, various steps in FIG. 15 could overlap, occur in parallel, occur in a different order, or occur any number of times.

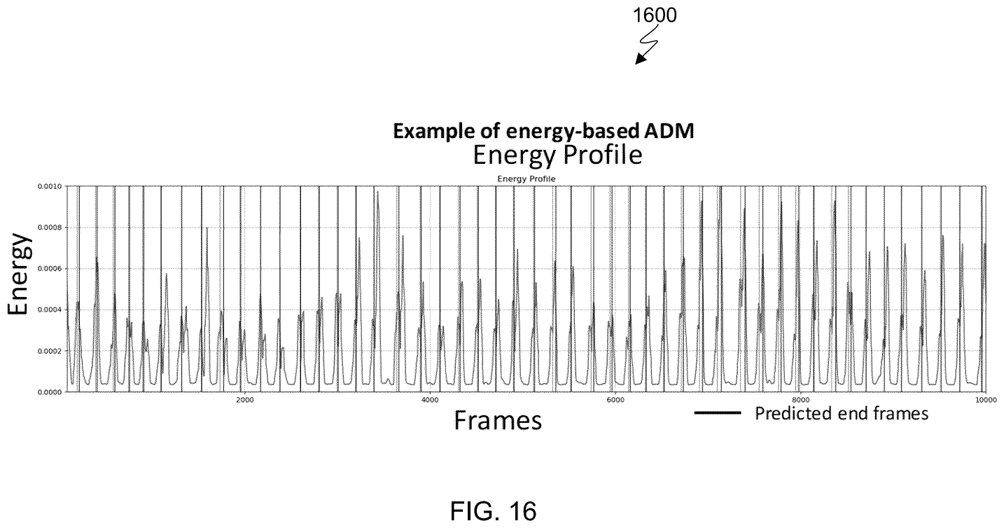

The advantage of an energy-based ADM is that it can predict both the start and end of the gesture. FIG. 16 shows one example of an energy-based ADM predicting the end of the gesture and a comparison to manually labeled end frames.

FIG. 16 illustrates an example of energy based ADM prediction 1600 according to embodiments of the present disclosure. The embodiment of the energy based ADM prediction of FIG. 16 is for illustration only. Different embodiments of energy based ADM prediction could be used without departing from the scope of this disclosure.

In the Example of FIG. 16, an energy profile is depicted over a plurality of frames. The energy profile shows predicted end frames based on a STA gating threshold.

Although FIG. 16 illustrates an example of energy based ADM prediction 1600, various changes may be made to FIG. 16. For example, various changes to the number of frames, the predictions, etc. could be made according to particular needs.

In one embodiment, for a machine learning ADM implementing threshold-based reinforcement, upper and lower bounds of energy are empirically calculated on normalized TVD (Time Velocity Diagram) plots with a threshold_n. Threshold_n is another threshold that is implemented on the TVD for suppressing background noise. In one embodiment, the normalization can be set between 0 and 1 and performed for a fixed number of frames of the gesture. After this a specific threshold is applied to reject noise and background data. This enables real and synthetic data to more similarly align in case their power levels are different. Such a normalization process can also be used to make the system environment independent and increase robustness. Implementing an upper and lower bound energy threshold and gesture length threshold can reduce false alarm rate.

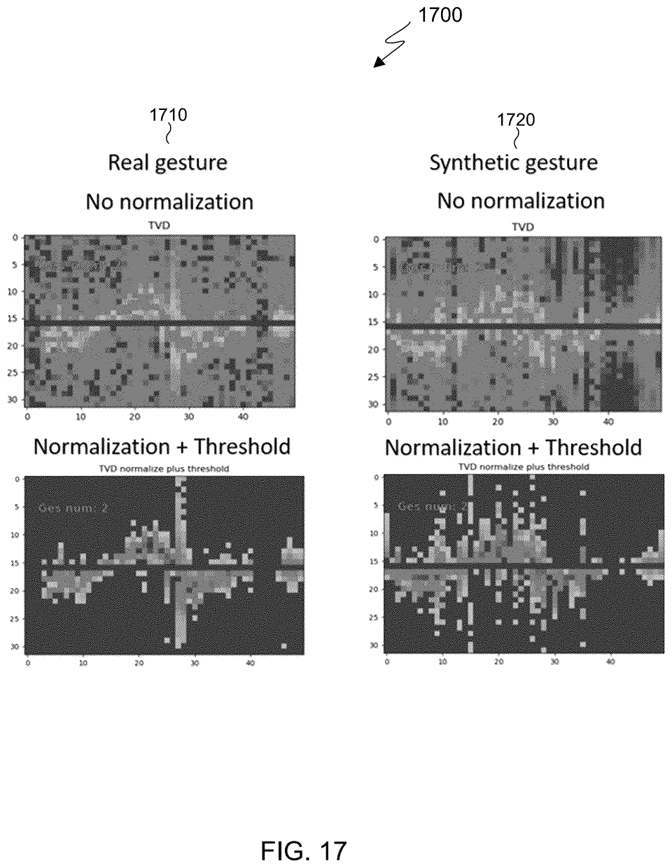

FIG. 17 illustrates an example 1700 of normalized data with a threshold vs non-normalized data for a real and synthetically generated gesture according to embodiments of the present disclosure. The embodiment of normalized data of FIG. 17 is for illustration only. Different embodiments of normalized data could be used without departing from the scope of this disclosure.

In the example of FIG. 17, both synthetic radar gesture 1710 and real radar gesture 1720 appear similar to each other after normalization and application of a threshold.

Although FIG. 17 illustrates an example 1700 of normalized data with a threshold vs non-normalized data, various changes may be made to FIG. 17. For example, various changes to the gestures, the threshold, etc. could be made according to particular needs.

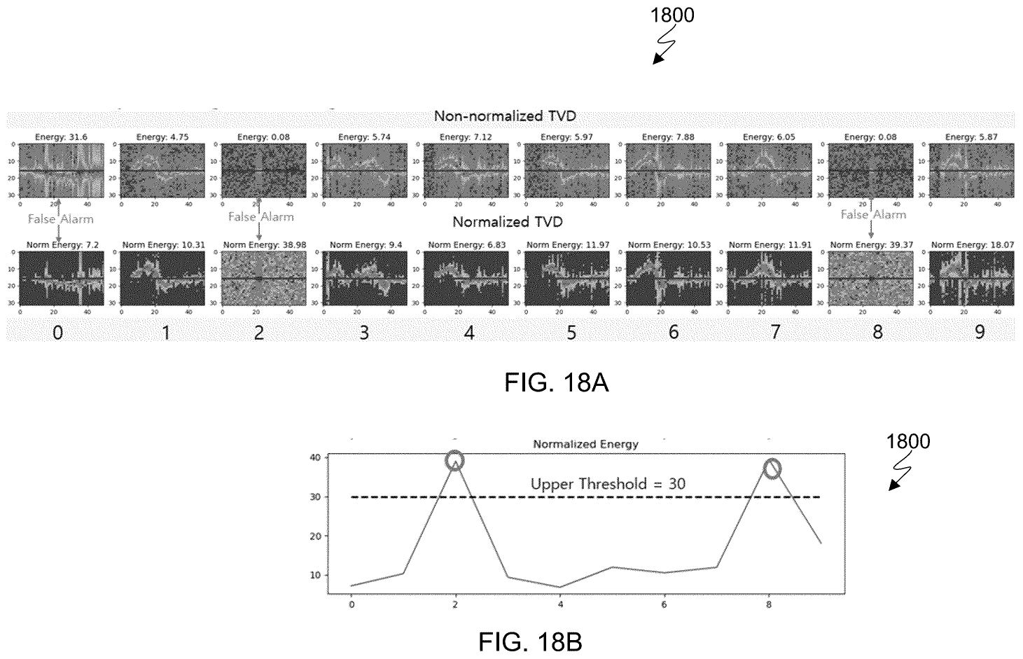

FIGS. 18A-18B illustrate an example 1800 of false alarm rejection according to embodiments of the present disclosure. The embodiment of false alarm rejection of FIGS. 18A-18B is for illustration only. Different embodiments of false alarm rejection could be used without departing from the scope of this disclosure.

FIG. 18A shows rejection of a false alarm comparison when an energy threshold is implemented on non-normalized and normalized TVD. FIG. 18B shows the plot of energy values for non-normalized and normalized TVD and the higher energy and lower energy thresholds. FIG. 18A shows an example of a series of 10 gestures, where the normalized TVD based energy and gesture length thresholds can successfully find false alarms in the dataset. It can be seen that when normalization is performed for data which mostly contains noise, each column has a much higher average power leading to more total power (Gesture 2 and Gesture 8). When there are strong signal components for legitimate reflections, the normalization is with respect to that power. Since the signal component appears across a small number of doppler bins, the rest of the bins are normalized to a much lower value leading to lower total power. The drastic difference between normalized power for gestures and false-alarms helps to implement more robust threshold values and reduce false-alarms.

Although FIGS. 18A-18B illustrate an example 1800 of false alarm rejection, various changes may be made to FIGS. 18A-18B. For example, various changes to the gestures, the threshold, etc. could be made according to particular needs.

In one embodiment, power weighted doppler is used for predicting false alarms. The power weighted doppler (PWD) can be calculated using equation (4).

$$PWD [ n ] = \frac{{\sum }_{k = - \frac{N}{2}}^{\frac{N}{2} - 1} k . TVD [ n , k ]}{{\sum }_{k = - \frac{N}{2}}^{\frac{N}{2} - 1} T V D [ n , k ]} \qquad ( 4 )$$

In equation (4), the power-weighted Doppler is the centroid of the power across Doppler (k), for each slow time index (n). Using this technique helps to envelope the essential signal component and retain the shape when transitioning from 2D to 1D data. The resulting energy sum is plotted for each of the frames, thereby changing a 2D TVD to a 1D PWD.

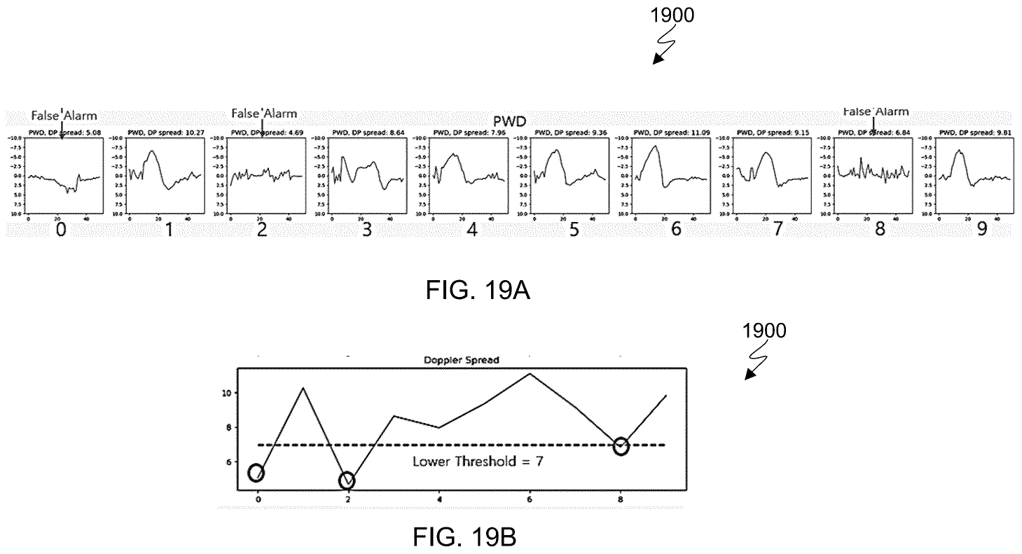

FIGS. 19A-19B illustrate another example 1900 of false alarm rejection according to embodiments of the present disclosure. The embodiment of false alarm rejection of FIGS. 19A-19B is for illustration only. Different embodiments of false alarm rejection could be used without departing from the scope of this disclosure.

FIG. 19A shows rejection of a false alarm comparison when an energy threshold is implemented using PWD. FIG. 19B shows the plot the doppler spread of the PWD with the higher and lower thresholds. The false alarms at gestures 0, 2 and 8 can be successfully detected by the PWD which shows that the PWD works well for rejecting false alarms.

Although FIGS. 19A-19B illustrate an example 1800 of false alarm rejection, various changes may be made to FIGS. 18A-18B. For example, various changes to the gestures, the threshold, etc. could be made according to particular needs.

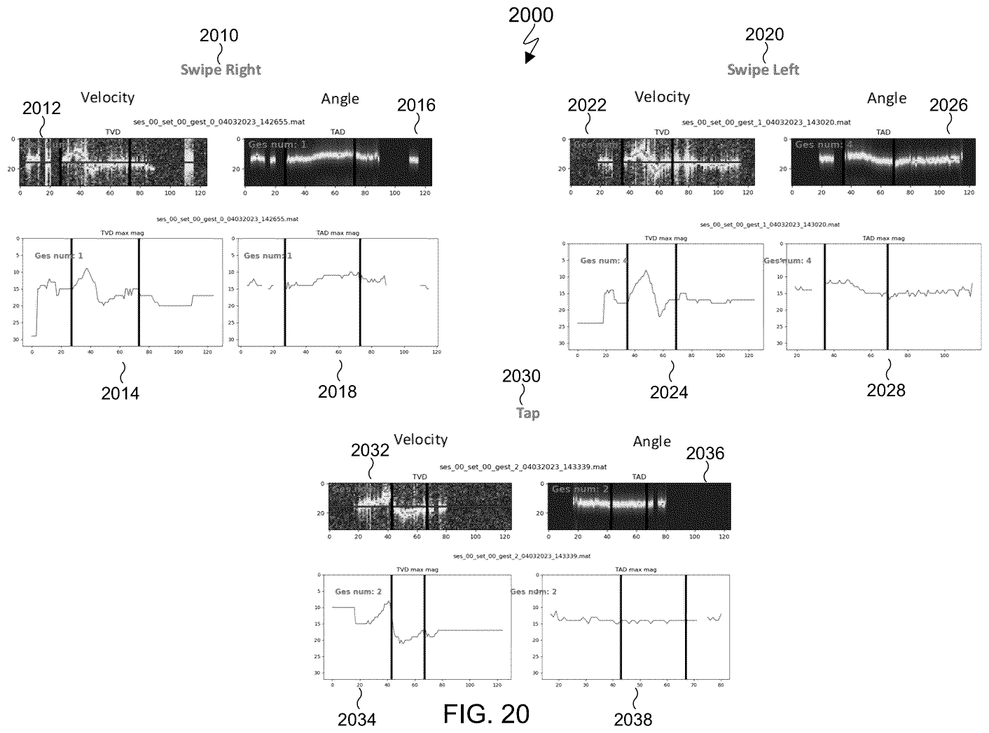

In one embodiment, instead of using 2D TVD images, only the highest energy doppler bin is selected in each frame to get 1D a velocity profile. Such a method helps to reduce the background noise present due to the environment and make the system more environment independent. In some embodiments, the classifier can be trained on the 1D images which can further improve the detection accuracy and reduce classifier CNN model complexity by just using one-dimensional data. FIG. 20 shows examples of conversion from 2D TVD plots to 1D TVD plots for some gestures.

FIG. 20 illustrates an example 2000 of conversion of 2D TVD and TAD data to 1D TVD and TAD data according to embodiments of the present disclosure. The embodiment of data conversion of FIG. 20 is for illustration only. Different embodiments of data conversion could be used without departing from the scope of this disclosure.

In the example of FIG. 20, conversion of 2D TVD and TAD data to 1D TVD and TAD is shown for three example gestures 2010, 2020, and 2030. Gesture 2010 is a swipe right gesture, where 2D TVD data 2012 is converted to 1D TVD data 2014, and 2D TAD data 2016 is converted to 1D TAD data 2018. Gesture 2020 is a swipe left gesture, where 2D TVD data 2022 is converted to 1D TVD data 2024, and 2D TAD data 2026 is converted to 1D TAD data 2028. Gesture 2030 is a tap gesture, where 2D TVD data 2032 is converted to 1D TVD data 2034, and 2D TAD data 2036 is converted to 1D TAD data 2038.

Although FIG. 20 illustrates an example 2000 of conversion of 2D TVD and TAD data to 1D TVD and TAD data, various changes may be made to FIG. 20. For example, various changes to the gestures, the data conversion, etc. could be made according to particular needs.

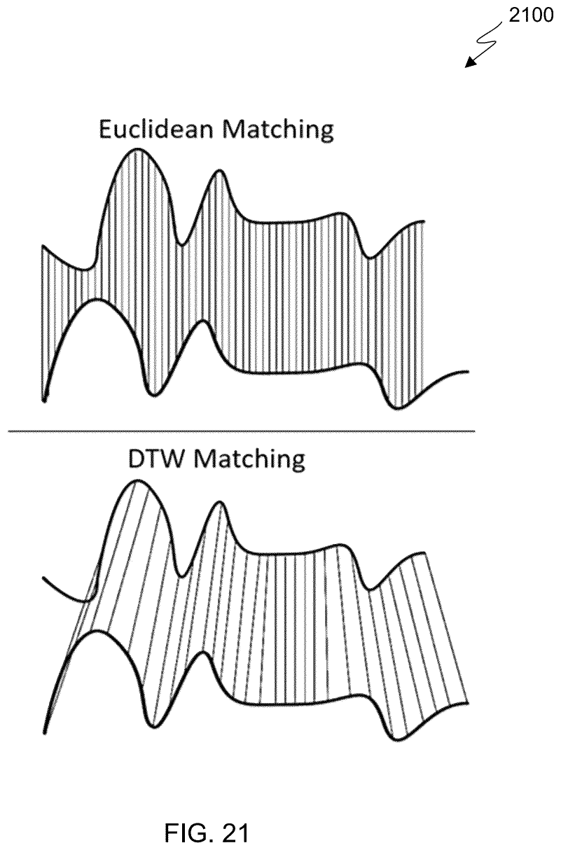

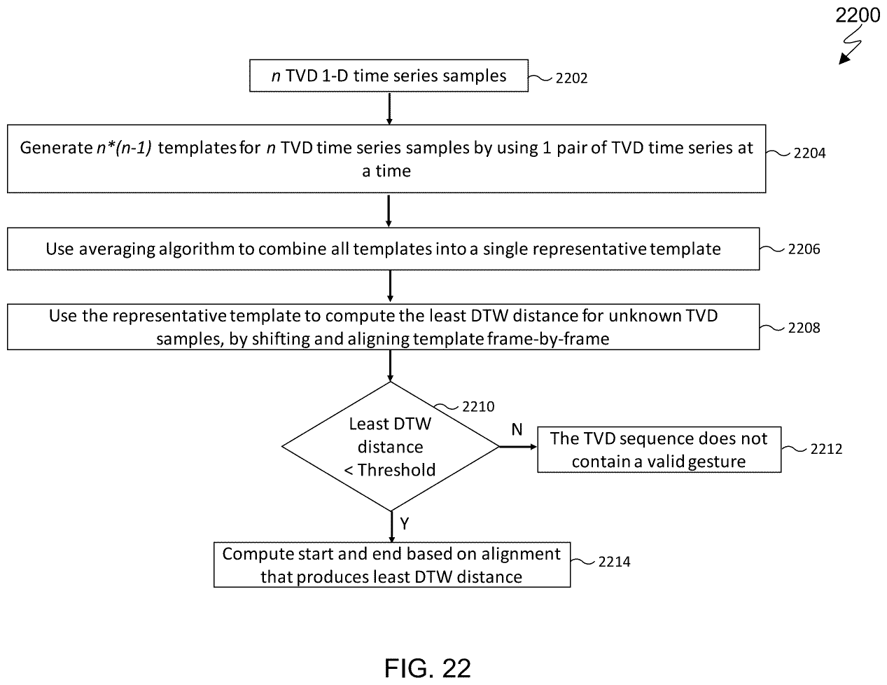

In one embodiment, 1D TVD data similar to as shown in FIG. 20 is used to train a non-machine learning based ADM for gesture start and end detection. This ADM approach is based on a technique called band relaxed segmented locally normalized dynamic time warping (SLN-DTW). In this technique, pairs of 1D velocity time series data are used to find a template of a minimum distance curve from either of the time series using dynamic time warping. Using this technique is better than some Euclidean matching approaches, since it accounts for shift in time or elongation or contraction of the sequence. FIG. 21 illustrates an example 2100 showing the distinction between the Euclidean and DTW matching. An example method for SLN-DTW matching to calculate gesture start and end is shown in FIG. 22. This may be referred to as an SLN-DTW operation.

FIG. 22 illustrates a method 2200 for SLN-DTW matching based activity detection according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a method 2200 for SLN-DTW matching based activity detection could be used without departing from the scope of this disclosure.

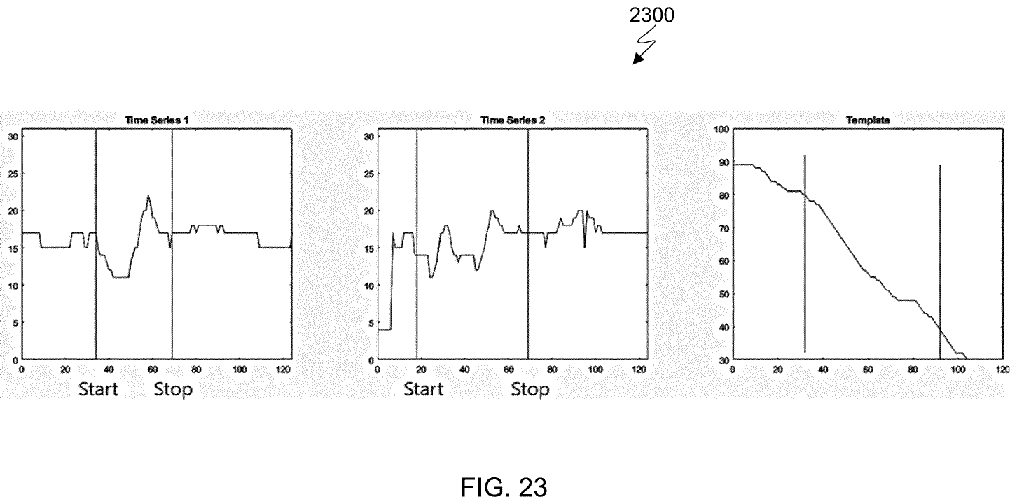

In the example of FIG. 22, SLN-DTW matching is implemented and various 1D TVD time series are compared to generate templates. Method 2200 begins at step 2202. At step 2202, time series samples are collected for different users. At step 2204, pairs of time series samples are compared to determine the optimal template that has the least overall DTW score from either of the time series. At step 2206, different such time series templates can be averaged to get a single representative time series template. FIG. 23 illustrates an example 2300 of a first and second time series and the template generated between them. This template is the least distance from either of the time series. Multiple such templates generated can be combined into one representative time series which represents all the time series data. This can be done using any averaging algorithm, such as a DTW barycenter averaging (DBA) algorithm, etc. All templates are averaged into one representative template. This single representative template can be used to find distances from unknown 1D TVD time series sequences. At step 2208, this representative time series template is used to calculate DTW scores on test data and determine the optimal start and end for the test data sequence. At step 2210, a determination is made whether a least DTW distance is less than a threshold. If the least DTW distance is greater than the threshold, at step 2212 it is determined that the TVD sequence does not contain a valid gesture. Otherwise, a gesture is present and at step 2214, a gesture start, and end are computed based on an alignment that produces the least DTW distance.

Although FIG. 22 illustrates one example of a method 2200 for SLN-DTW matching based activity detection, various changes may be made to FIG. 22. For example, while shown as a series of steps, various steps in FIG. 22 could overlap, occur in parallel, occur in a different order, or occur any number of times.

The ADM method of FIG. 22 is implemented using non-machine learning techniques and provides an alternative low-complexity, environment independent approach to detect the start and end of gesture activity. Also, since both start and end can be detected, the gesture can be resampled to eliminate pre-gesture contribution.

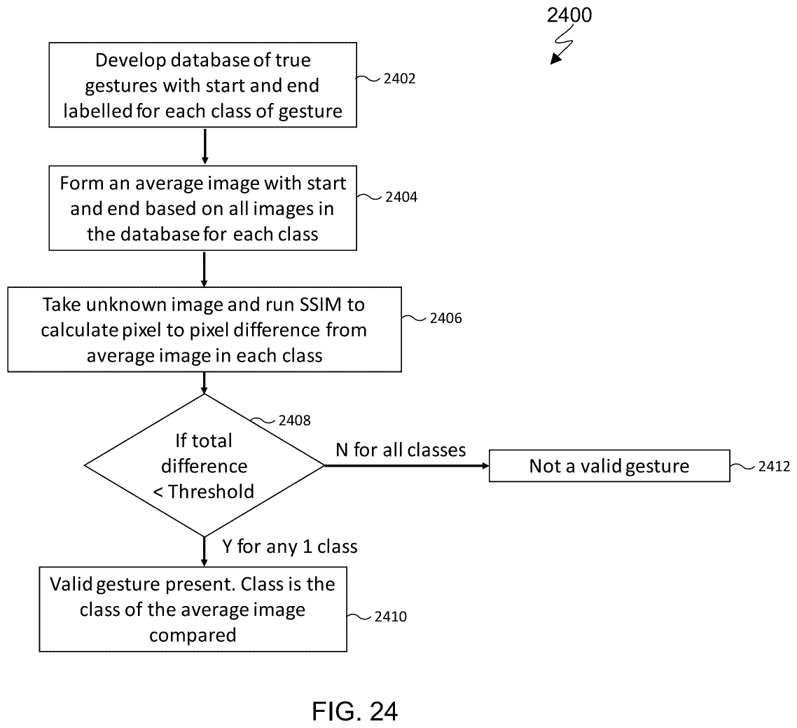

In one embodiment, the structural similarity index measure (SSIM) technique is used to replace the classifier module. The SSIM technique is based on finding similarities between a known and unknown image. An example method of using the SSIM technique for predicting the class of a gesture is shown in FIG. 24. This may be referred to as an SSIM operation.

FIG. 24 illustrates a method 2400 for SSIM based gesture classification according to embodiments of the present disclosure. An embodiment of the method illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a method 2400 for SSIM based gesture classification could be used without departing from the scope of this disclosure.

In the example of FIG. 24, method 2400 begins at step 2402. At step 2402, an SSIM technique uses a database of known TVD and TAD images with labeled gesture types. The database of known images contains different variances of the same gesture type. In one embodiment, these variances can also be generated using synthetic simulations. At step 2404, once the database is ready, a template is generated that is representative of the database by averaging all images. At step 2406, the template is used to test the unknown TVD by calculating a pixel to pixel difference. If the total difference is less than an empirically set threshold at step 2408, then at step 2410 the unknown TVD belongs the same particular class of the gesture as the template. Otherwise, at step 2412 the TVD does not belong to a valid gesture.

Although FIG. 24 illustrates one example of a method 2400 for SSIM based gesture classification, various changes may be made to FIG. 24. For example, while shown as a series of steps, various steps in FIG. 24 could overlap, occur in parallel, occur in a different order, or occur any number of times.

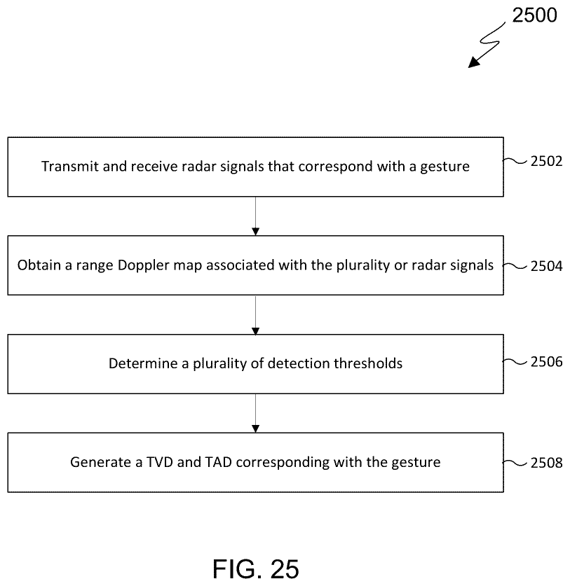

FIG. 25 illustrates a method 2500 for macro gesture recognition accuracy improvement according to embodiments of the present disclosure. An embodiment of the method illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of a method 2500 for macro gesture recognition accuracy improvement could be used without departing from the scope of this disclosure.

In the example of FIG. 25, method 2500 begins at step 2502. At step 2502, an electronic device transmits and receives a plurality of radar signals corresponding with a gesture. At step 2504, the electronic device obtains a range Doppler map associated with the plurality of radar signals. At step 2506, the electronic device determines a plurality of detection thresholds. Each detection threshold corresponds with a rang-bin value of the range Doppler map. Finally, at step 2508, the electronic device generates, based on the determined plurality of detections thresholds, a TVD and a TAD corresponding with the gesture.

Although FIG. 25 illustrates one example of a method 2500 for macro gesture recognition accuracy improvement, various changes may be made to FIG. 25. For example, while shown as a series of steps, various steps in FIG. 25 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a transceiver configured to transmit and receive a plurality of radar signals corresponding with a gesture; and
a processor operatively coupled to the transceiver, the processor configured to:
obtain a range Doppler map associated with the plurality of radar signals;
determine a plurality of detection thresholds, each detection threshold corresponding with a range-bin value of the range Doppler map; and
generate, based on the determined plurality of detection thresholds, a time velocity diagram (TVD) and a time angle diagram (TAD) corresponding with the gesture.

2. The electronic device of claim 1, wherein the processor is further configured to:
determine, based on the TVD, a gesture energy;
identify, based on the gesture energy, whether the gesture is an invalid gesture; and
if the gesture is not an invalid gesture, classify the gesture.

3. The electronic device of claim 2, wherein to identify whether the gesture is a valid gesture, the processor is further configured to:
determine whether the gesture energy exceeds a lower energy threshold;
determine whether the gesture energy exceeds an upper energy threshold;
if the gesture fails to exceed the lower energy threshold, identify the gesture as an invalid gesture; and
if the gesture exceeds the upper energy threshold, identify the gesture as an invalid gesture.

4. The electronic device of claim 1, wherein the processor is further configured to:
determine, based on the TVD, a start frame and an end frame corresponding to the gesture;
resample TAD data and TVD data between the start frame and the end frame, wherein the resampled TAD data and TVD data has a length equal to a predetermined maximum length; and
classify the gesture based on the resampled TAD and TVD data.

5. The electronic device of claim 4, wherein:
to determine the start frame and the end frame, the processor is further configured to perform a segmented locally normalized dynamic time warping (SLN-DTW) operation on the TVD; and
the determination of the start frame and the end frame is based on a result of the SLN-DTW operation.

6. The electronic device of claim 4, wherein:
to determine the start frame and the end frame, the processor is further configured to perform a short-term average (STA) power operation on the TVD; and
the determination of the start frame and the end frame is based on a result of the STA power operation.

7. The electronic device of claim 4, wherein:
the processor is further configured to perform a structural similarity index measure (SSIM) operation on the resampled TAD and TVD data; and
the classification of the gesture is based on a result of the SSIM operation.

8. A method of operating an electronic device, the method comprising:
transmitting and receiving a plurality of radar signals corresponding with a gesture;
obtaining a range Doppler map associated with the plurality of radar signals;
determining a plurality of detection thresholds, each detection threshold corresponding with a range-bin value of the range Doppler map; and
generating, based on the determined plurality of detection thresholds, a time velocity diagram (TVD) and a time angle diagram (TAD) corresponding with the gesture.

9. The method of claim 8, further comprising:
determining, based on the TVD, a gesture energy;
identifying, based on the gesture energy, whether the gesture is an invalid gesture; and
if the gesture is not an invalid gesture, classifying the gesture.

10. The method of claim 9, identifying whether the gesture is a valid gesture comprises:
determining whether the gesture energy exceeds a lower energy threshold;
determining whether the gesture energy exceeds an upper energy threshold;
if the gesture fails to exceed the lower energy threshold, identifying the gesture as an invalid gesture; and
if the gesture exceeds the upper energy threshold, identifying the gesture as an invalid gesture.

11. The method of claim 8, further comprising:
determining, based on the TVD, a start frame and an end frame corresponding to the gesture;
resampling TAD and TVD data between the start frame and the end frame, wherein the resampled TAD and TVD data has a length equal to a predetermined maximum length; and
classifying the gesture based on the resampled TAD and TVD data.

12. The method of claim 11, further comprising performing a segmented locally normalized dynamic time warping (SLN-DTW) operation on the TVD,
wherein determining the start frame and the end frame is based on a result of the SLN-DTW operation.

13. The method of claim 11, further comprising performing a short-term average (STA) power operation on the TVD,
wherein determining the start frame and the end frame is based on a result of the STA power operation.

14. The method of claim 11, further comprising performing a structural similarity index measure (SSIM) operation on the resampled TAD and TVD data,
wherein classifying the gesture is based on a result of the SSIM operation.

15. A non-transitory computer readable medium embodying a computer program, the computer program comprising program code that, when executed by a processor of a device, causes the device to:
transmit and receiving a plurality of radar signals corresponding with a gesture;
obtain a range Doppler map associated with the plurality of radar signals;
determine a plurality of detection thresholds, each detection threshold corresponding with a range-bin value of the range Doppler map; and
generate, based on the determined plurality of detection thresholds, a time velocity diagram (TVD) and a time angle diagram (TAD) corresponding with the gesture.

16. The non-transitory computer readable medium of claim 15, wherein the computer program further comprises computer readable program code that when executed causes at least one processing device to:
determine, based on the TVD, a gesture energy;
determine whether the gesture energy exceeds a lower energy threshold;
determine whether the gesture energy exceeds an upper energy threshold;
if the gesture fails to exceed the lower energy threshold, identify the gesture as an invalid gesture;
if the gesture exceeds the upper energy threshold, identify the gesture as an invalid gesture; and
if the gesture is not identified as an invalid gesture, classify the gesture.

17. The non-transitory computer readable medium of claim 15, wherein the computer program further comprises computer readable program code that when executed causes at least one processing device to:
determine, based on the TVD, a start frame and an end frame corresponding to the gesture;
resample TAD data and TVD data between the start frame and the end frame, wherein the resampled TAD data and TVD data has a length equal to a predetermined maximum length; and
classify the gesture based on the resampled TAD and TVD data.

18. The non-transitory computer readable medium of claim 17, wherein the computer program further comprises computer readable program code that when executed causes at least one processing device to:
perform a segmented locally normalized dynamic time warping (SLN-DTW) operation on the TVD,
wherein the start frame and the end frame are determined based on a result of the SLN-DTW operation.

19. The non-transitory computer readable medium of claim 17, wherein the computer program further comprises computer readable program code that when executed causes at least one processing device to:
perform a short-term average (STA) power operation on the TVD,
wherein the start frame and the end frame are determined based on a result of the STA power operation.

20. The non-transitory computer readable medium of claim 17, wherein the computer program further comprises computer readable program code that when executed causes at least one processing device to:
perform a structural similarity index measure (SSIM) operation on the resampled TAD and TVD data,
wherein the gesture is classified based on a result of the SSIM operation.
